(19) United States
(12) Patent Application Publication
(10) Pub. No.: US 2026/0092528 A1
(43) Pub. Date: Apr. 2, 2026

(54) TURBINE STATOR VANE AND GAS TURBINE

(71) Applicant: MITSUBISHI HEAVY INDUSTRIES, LTD., Tokyo (JP)

(72) Inventors: Yasuo MIYAHISA, Tokyo (JP); Saki MATSUO, Tokyo (JP); Shunsuke TORII, Tokyo (JP); Keiya ISHIYAMA, Tokyo (JP)

(21) Appl. No.: 19/111,513

(22) PCT Filed: Aug. 16, 2023
(86) PCT No.: PCT/JP2023/029575

§ 371 Date: Mar. 13, 2025

(30) Foreign Application Priority Data
Sep. 20, 2022 (JP) 2022-149115

(51) Int. Cl. F01D 5/18; F01D 9/04

(52) U.S. Cl. CPC F01D 5/187; F01D 9/041; F05D 2240/121; F05D 2240/123; F05D 2240/124; F05D 2260/201

(57) ABSTRACT

A turbine stator vane includes a first partition wall and a second partition wall which partition the internal space of an airfoil, and a plurality of through-holes penetrating a vane wall constituting the airfoil. The first partition wall extends from the vane wall on the pressure side of the airfoil to the vane wall on the negative pressure side of the airfoil, and is provided at the position nearest to the leading edge. The second partition wall extends from the vane wall on the leading edge side of the airfoil to the first partition wall, and partitions the internal space into a pressure-side leading edge cavity and a negative pressure-side leading edge cavity. An intersection angle between a first virtual straight line and the extending direction of the vane wall is an obtuse angle at the leading edge and an acute angle at the trailing edge.

### TECHNICAL FIELD

The present disclosure relates to a turbine stator vane and a gas turbine.

The present application claims the benefit of priority based on Japanese Patent Application No. 2022-149115 filed to the Japanese Patent Office on Sep. 20, 2022, the content of which is incorporated herein by reference.

### BACKGROUND ART

As a turbine stator vane of a gas turbine, a turbine stator vane configured such that a vane wall is film-cooled by cooling air ejected from an internal space of an airfoil via a film cooling hole, which is a through-hole of the vane wall, is known (for example, refer to PTL 1).

### CITATION LIST

### Patent Literature

[PTL 1] Japanese Unexamined Patent Application Publication No. 2001-140602

### SUMMARY OF INVENTION

### Technical Problem

Regarding a vane wall on a leading edge side of a turbine stator vane, a pressure surface side and a suction surface side significantly differ in pressure of a working fluid acting on the vane wall. Therefore, in a case where cooling air in the same cavity on the leading edge side is ejected through a film cooling hole provided in a vane wall on the pressure surface side and a film cooling hole provided in a vane wall on the suction surface side as in the case of, for example, a turbine stator vane described in PTL 1, the flow rate of cooling air from the film cooling hole provided in the vane wall on the suction surface side becomes excessive. As a result, the efficiency of a gas turbine may be decreased.

At least one embodiment of the present disclosure is made in view of the above-described circumstances, and an object of the present disclosure is to optimize the amount of cooling air in a turbine stator vane.

### Solution to Problem

(1) According to at least one embodiment of the present disclosure, there is provided a turbine stator vane including a first partition wall and a second partition wall that partition an internal space of an airfoil, and a plurality of through-holes that penetrate vane walls constituting the airfoil, in which the first partition wall is a partition wall that extends from a pressure surface side connection position, which is a connection position between the first partition wall and the vane wall on a pressure surface side of the airfoil, to a suction surface side connection position, which is a connection position between the first partition wall and the vane wall on a suction surface side of the airfoil, and is provided closest to a leading edge of the airfoil, the second partition wall extends from a leading edge side connection position, which is a connection position between the second partition wall and the vane wall on a leading edge side of the airfoil, to a trailing edge side connection position, which is a connection position between the second partition wall and the first partition wall, and partitions the internal space into a pressure surface side leading edge cavity and a suction surface side leading edge cavity, of angles of intersection between a first virtual straight line that passes through the pressure surface side connection position and the suction surface side connection position and an extending direction of the vane wall at the suction surface side connection position, an angle of intersection that is on the leading edge side with respect to the first virtual straight line is an obtuse angle, and an angle of intersection that is on a trailing edge side of the airfoil with respect to the first virtual straight line is an acute angle as seen in a vane height direction of the airfoil, and the through-holes include pressure surface side through-holes that open into the pressure surface side leading edge cavity and suction surface side through-holes that open into the suction surface side leading edge cavity.
(2) According to at least one embodiment of the present disclosure, there is provided a gas turbine including the turbine stator vane having a configuration according to (1) described above.

### Advantageous Effects of Invention

According to at least one embodiment of the present disclosure, it is possible to optimize the amount of cooling air in a turbine stator vane.

### BRIEF DESCRIPTION OF DRAWINGS

FIG. 1 is a schematic view showing an entire configuration of a gas turbine.

FIG. 2 is a cross-sectional view showing a gas flow path of the turbine.

FIG. 3 is a cross-sectional view of an airfoil of a turbine first-stage stator vane according to an embodiment, which shows a cross section orthogonal to a vane height direction.

FIG. 4 is an enlarged view of part A of FIG. 3 and is a view for description of a way in which cooling air flows.

FIG. 5 is an enlarged view of part A of FIG. 3 and is a view for description of partition walls in the airfoil.

FIG. 6 is a view for description of partition walls in an airfoil of a turbine first-stage stator vane according to another embodiment.

FIG. 7 is a view for description of partition walls in an airfoil of a turbine first-stage stator vane according to still another embodiment.

### DESCRIPTION OF EMBODIMENTS

Hereinafter, several embodiments of the present disclosure will be described with reference to the accompanying drawings. Dimensions, materials, shapes, relative arrangements, and the like of components described as embodiments or shown in the drawings are not intended to limit the scope of the present disclosure, but are merely explanatory examples.

For example, an expression representing a relative or absolute arrangement such as “in a certain direction”, “along a certain direction”, “parallel”, “orthogonal”, “center”, “concentric”, or “coaxial” does not strictly represent only such an arrangement, but also a tolerance or a state of being relatively displaced with an angle or a distance to the extent that the same function can be obtained.

For example, expressions such as “identical”, “equal”, and “homogeneous” indicating that things are in an equal state do not strictly represent only the equal state, but also a tolerance or a state where there is a difference to the extent that the same function can be obtained.

For example, an expression representing a shape such as a quadrangular shape or a cylindrical shape does not represent only a shape such as a quadrangular shape or a cylindrical shape in a geometrically strict sense, but also a shape including an uneven portion, a chamfered portion, and the like within a range in which the same effect can be obtained.

Meanwhile, the expressions “being provided with”, “comprising”, “including”, or “having” one component are not exclusive expressions excluding the presence of other components.

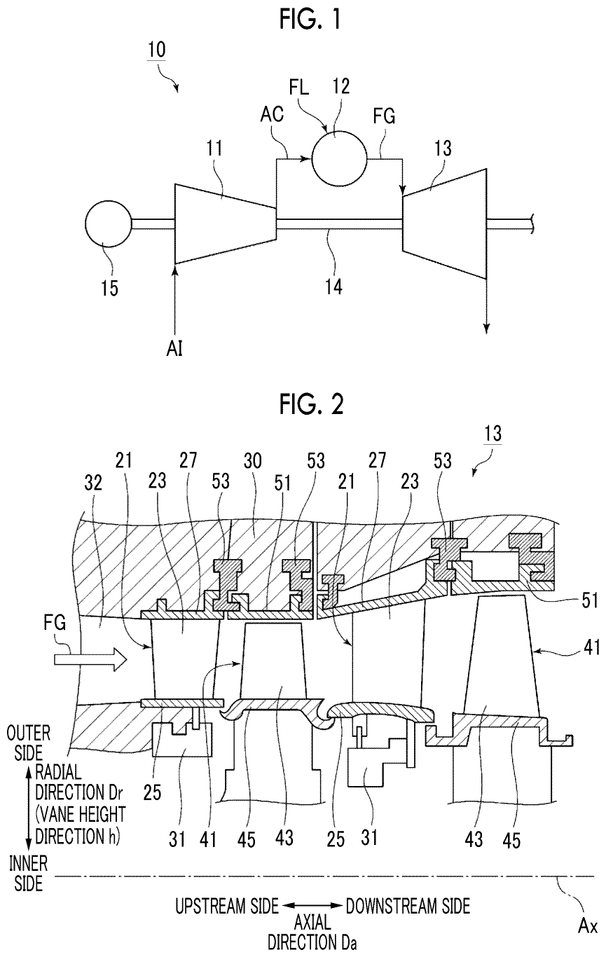

FIG. 1 is a schematic view showing an overall configuration of a gas turbine and FIG. 2 is a cross-sectional view showing a gas flow path of the turbine.

In the present embodiment, as shown in FIG. 1, a gas turbine 10 is configured such that a compressor 11, a combustor 12, and a turbine 13 are disposed to be coaxial with each other by means of a rotor 14, and a generator 15 is connected to one end portion of the rotor 14. Note that in the following description, a direction in which an axis of the rotor 14 extends will be referred to as an axial direction Da and a direction perpendicular to an axis Ax of the rotor 14 will be referred to as a radial direction Dr. Note that the radial direction Dr will be referred to as a vane height direction h.

In the compressor 11, air AI taken in through an air intake port passes through a plurality of stator vanes and rotor blades and is compressed so that high-temperature and high-pressure compressed air AC is generated. The combustor 12 supplies a predetermined fuel FL to the compressed air AC and combusts the compressed air AC to generate a high-temperature and high-pressure combustion gas FG. In the turbine 13, the high-temperature and high-pressure combustion gas FG, which is a working fluid and is generated in the combustor 12, passes through a plurality of stator vanes and rotor blades to rotationally drive the rotor 14 and to drive the generator 15 connected to the rotor 14.

In addition, as shown in FIG. 2, in the turbine 13, turbine stator vanes (stator vanes) 21 are configured such that hub sides (an inner side in the radial direction Dr) of airfoils 23 are fixed to inner shrouds 25 and distal end sides (an outer side in the radial direction Dr) of the airfoils 23 are fixed to outer shrouds 27. Turbine rotor blades (rotor blades) 41 are configured such that proximal end portions of airfoils 43 are fixed to platforms 45. In addition, the outer shrouds 27 and ring segments 51 which are disposed close to distal end portions of the rotor blades 41 are supported by a casing (a turbine casing) 30 via thermal insulation rings 53, and the inner shrouds 25 are supported by support rings 31. Therefore, a combustion gas flow path 32 through which the combustion gas FG passes is formed along the axial direction Da as a space surrounded by the inner shrouds 25, the outer shrouds 27, the platforms 45, and the ring segments 51.

Hereinafter, turbine first-stage stator vanes 21A, which are disposed closest to an upstream side in the axial direction Da among the turbine stator vanes 21 disposed in a plurality of stages in the axial direction Da, will be described in detail.

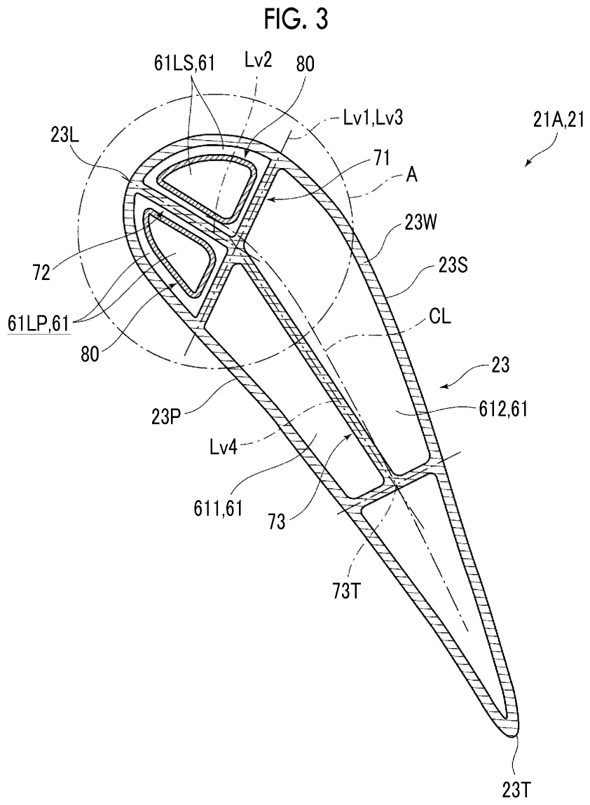

FIG. 3 is a cross-sectional view of the airfoil 23 of the turbine first-stage stator vane 21A according to an embodiment, which shows a cross section orthogonal to the vane height direction.

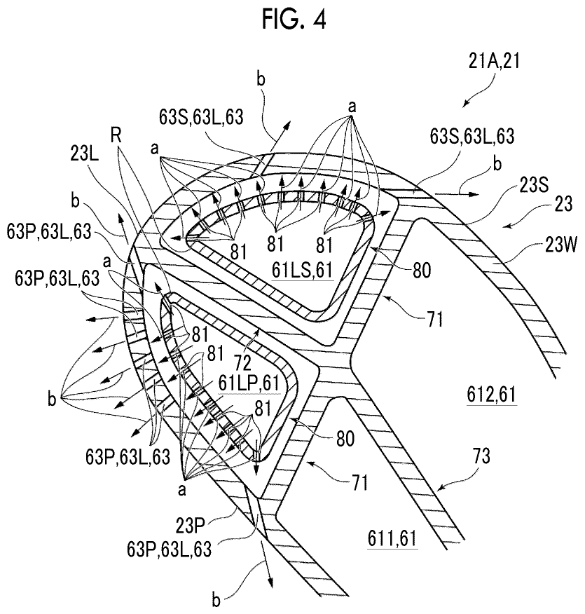

FIG. 4 is an enlarged view of part A of FIG. 3 and is a view for description of a way in which cooling air flows.

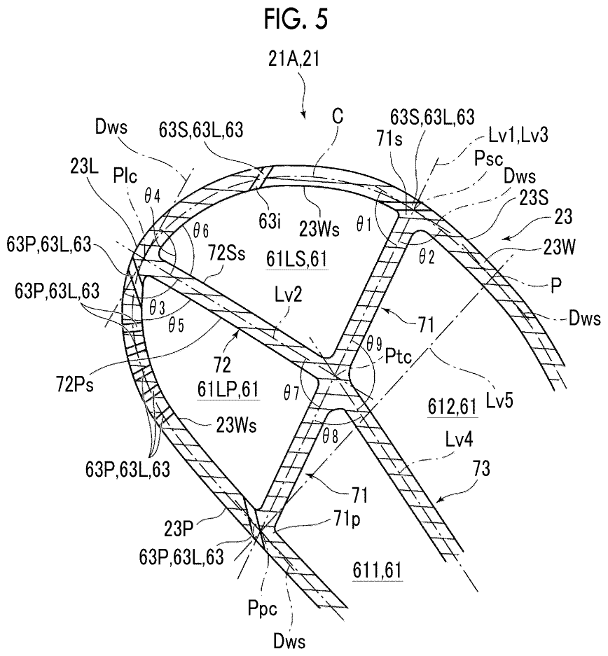

FIG. 5 is an enlarged view of part A of FIG. 3 and is a view for description of partition walls in the airfoil 23.

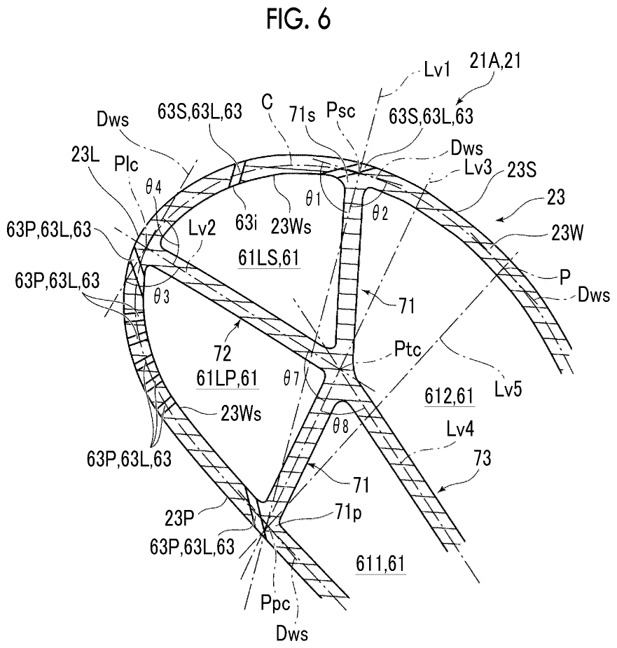

FIG. 6 is a view for description of partition walls in the airfoil 23 of the turbine first-stage stator vane 21A according to another embodiment and is a view corresponding to an enlarged view of part A of FIG. 3.

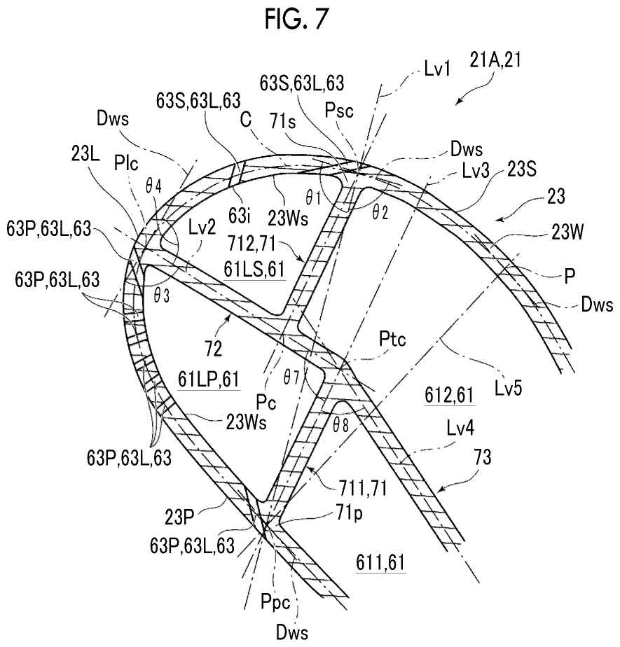

FIG. 7 is a view for description of partition walls in the airfoil 23 of the turbine first-stage stator vane 21A according to still another embodiment and is a view corresponding to an enlarged view of part A of FIG. 3.

Note that in FIG. 3, for the sake of convenience of illustration, through-holes 63 which will be described later and cooling air holes 81 of insert members 80 which will be described later are not shown.

In addition, in FIGS. 3 to 7, for the sake of convenience of illustration, some or all of the insert members 80 are not shown.

An internal space 61 is formed in the airfoil 23 of each of the turbine first-stage stator vanes 21A according to several embodiments shown in FIGS. 3 to 7. Each of the turbine first-stage stator vanes 21A according to the several embodiments includes a first partition wall 71, a second partition wall 72, and a third partition wall 73 that partition the internal space 61, and a plurality of through-holes 63 that penetrate vane walls 23W constituting the airfoil 23.

### First Partition Wall 71

In each of the turbine first-stage stator vanes 21A according to the several embodiments shown in FIGS. 3 to 7, as shown in FIGS. 5 to 7, the first partition wall 71 is a partition wall that extends from a pressure surface side connection position Ppc, which is a connection position between the first partition wall 71 and the vane wall 23W on a pressure surface 23P side of the airfoil 23, to a suction surface side connection position Psc, which is a connection position between the first partition wall 71 and the vane wall 23W on a suction surface 23S side of the airfoil 23, and is provided closest to a leading edge 23L of the airfoil 23.

In each of the turbine first-stage stator vanes 21A according to the several embodiments, the first partition wall 71 includes a pressure surface side end portion 71p that is connected to the vane wall 23W on the pressure surface 23P side and a suction surface side end portion 71s that is connected to the vane wall 23W on the suction surface 23S side.

In the turbine first-stage stator vane 21A according to the embodiment shown in FIGS. 3, 4, and 5, the first partition wall 71 is linearly formed along a first virtual straight line Lv1 that passes through the pressure surface side connection position Ppc and the suction surface side connection position Psc as seen in the vane height direction h.

In the turbine first-stage stator vane 21A according to another embodiment that is shown in FIG. 6, the first partition wall 71 is bent at a trailing edge side connection position Ptc, which is a connection position between the first partition wall 71 and the second partition wall 72, as seen in the vane height direction h and the trailing edge side connection position Ptc is positioned closer to a trailing edge 23T than the first virtual straight line Lv1 is. That is, in the turbine first-stage stator vane 21A according to the other embodiment that is shown in FIG. 6, the first partition wall 71 is bent to protrude toward the trailing edge 23T side.

In the turbine first-stage stator vane 21A according to still another embodiment that is shown in FIG. 7, the first partition wall 71 includes a pressure surface side region 711 that extends from the pressure surface side connection position Ppc to the trailing edge side connection position Ptc as seen in the vane height direction h and a suction surface side region 712 that extends from a connection position Pc, at which the first partition wall 71 is connected to the second partition wall 72, to the suction surface side connection position Psc as seen in the vane height direction h at a position that is closer to the leading edge 23L side than the trailing edge side connection position Ptc is. That is, in the turbine first-stage stator vane 21A according to the other embodiment that is shown in FIG. 7, the first partition wall 71 is formed to be stepped.

In each of the turbine first-stage stator vanes 21A according to the several embodiments, as shown in FIGS. 5 to 7, of the angles of intersection between the first virtual straight line Lv1 and an extending direction Dws of the vane wall 23W at the suction surface side connection position Psc, an angle θ1 of intersection that is on the leading edge 23L side with respect to the first virtual straight line Lv1 is an obtuse angle and an angle θ2 of intersection that is on the trailing edge 23T side with respect to the first virtual straight line Lv1 is an acute angle as seen in the vane height direction h.

Note that in the present application, the extending direction Dws of the vane wall 23W is an extending direction of a line tangent to a center line C of the thickness of the vane wall 23W as seen in the vane height direction h. For example, in a case in which a straight line, such as the first virtual straight line Lv1, and the extending direction Dws intersect with each other, the extending direction of the extending direction Dws at the position of intersection between the straight line and the extending direction Dws is an extending direction of a line tangent to the center line C of the thickness of the vane wall 23W at the position of intersection.

### Second Partition Wall 72

In each of the turbine first-stage stator vanes 21A according to the several embodiments shown in FIGS. 3 to 7, the second partition wall 72 extends from a leading edge side connection position Plc, which is a connection position between the second partition wall 72 and the vane wall 23W on the leading edge 23L side, to the trailing edge side connection position Ptc, which is a connection position between the second partition wall 72 and the first partition wall 71, and partitions the internal space 61 into a pressure surface side leading edge cavity 61LP and a suction surface side leading edge cavity 61LS.

Note that as shown in FIGS. 5 to 7, a virtual straight line that passes through the leading edge side connection position Plc and the trailing edge side connection position Ptc as seen in the vane height direction h will be referred to as a second virtual straight line Lv2. The influence of an angle θ3 of intersection (or an angle θ4 of intersection) between the second virtual straight line Lv2 and the extending direction Dws of the vane wall 23W at the leading edge side connection position Plc on the amount of cooling air in the turbine stator vane 21 will be described in detail.

### Third Partition Wall 73

In each of the turbine first-stage stator vanes 21A according to the several embodiments shown in FIGS. 3 to 7, the third partition wall 73 is a partition wall that extends toward the trailing edge 23T from the trailing edge side connection position Ptc and that partitions the internal space 61. Of the internal spaces 61 partitioned by the third partition wall 73, the internal space 61 that is on the pressure surface 23P side in comparison with the third partition wall 73 is a pressure surface side cavity 611 and the internal space 61 that is on the suction surface 23S side in comparison with the third partition wall 73 is a suction surface side cavity 612.

In each of the turbine first-stage stator vanes 21A according to the several embodiments, the third partition wall 73 is provided to contribute to an increase in strength of the first partition wall 71.

### Through-Hole 63

In each of the turbine first-stage stator vanes 21A according to the several embodiments shown in FIGS. 3 to 7, as shown in FIGS. 4 to 7, the through-holes 63 include pressure surface side through-holes 63P that open into the pressure surface side leading edge cavity 61LP and suction surface side through-holes 63S that open into the suction surface side leading edge cavity 61LS.

In each of the turbine first-stage stator vanes 21A according to the several embodiments, the pressure surface side through-holes 63P may form through-hole rows 63L that are disposed at intervals in the vane height direction h. The number of the through-hole rows 63L, each of which being composed of the pressure surface side through-holes 63P, may be two or more. In examples shown in FIGS. 4 to 7, the number of the through-hole rows 63L is, for example, seven.

Of a plurality of the through-hole rows 63L, each of which being composed of the pressure surface side through-holes 63P, the through-hole row 63L that is closest to the trailing edge 23T may intersect the first virtual straight line Lv1 as seen in the vane height direction h.

In each of the turbine first-stage stator vanes 21A according to the several embodiments, the suction surface side through-holes 63S may form the through-hole rows 63L that are disposed at intervals in the vane height direction h. The number of the through-hole rows 63L, each of which being composed of the suction surface side through-holes 63S, may be two.

Accordingly, the entirety of a region of the vane wall 23W on the suction surface 23S side that is in the vicinity of the leading edge 23L can be efficiently film-cooled by means of a relatively small amount of cooling air.

Regarding the vane wall 23W in the vicinity of the suction surface side connection position Psc, it is difficult to impingement-cool an inner wall surface 23Ws of the vane wall 23W since the first partition wall 71 is present.

Therefore, in each of the turbine first-stage stator vanes 21A according to the several embodiments, of two through-hole rows 63L, each of which being composed of the suction surface side through-holes 63S, the through-hole row 63L that is close to the trailing edge 23T may intersect the first virtual straight line Lv1 as seen in the vane height direction h.

Accordingly, the vane wall 23W in the vicinity of the suction surface side connection position Psc, which is difficult to impingement-cool, can be cooled through convective cooling by means of cooling air that passes through a plurality of the through-holes 63 constituting the through-hole row 63L close to the trailing edge 23T side.

### Insert Members 80

In each of the turbine first-stage stator vanes 21A according to the several embodiments shown in FIGS. 3 to 7, the tubular insert members 80, each of which being provided with a plurality of the cooling air holes 81 in a peripheral surface thereof, are provided. In each of the turbine first-stage stator vanes 21A according to the several embodiments, the insert members 80 are inserted into at least the pressure surface side leading edge cavity 61LP, the suction surface side leading edge cavity 61LS, the pressure surface side cavity 611, and the suction surface side cavity 612.

The insert members 80 are formed along respective inner peripheral surfaces of the cavities 61LP, 61LS, 611, and 612 to match the shapes of the cavities 61LP, 61LS, 611, and 612 as seen in the vane height direction.

The vane walls 23W defining the cavities 61LP, 61LS, 611, and 612 can be impingement-cooled by means of cooling air that is ejected from the insides of the insert members 80 to the outsides of the insert members 80 as represented by arrows a in FIG. 4 via the plurality of cooling air holes 81 of the insert members 80 respectively inserted into the cavities 61LP, 61LS, 611, and 612.

After impingement-cooling of inner wall surfaces of the vane walls 23W in the cavities 61LP, 61LS, 611, and 612, the cooling air is ejected to the outside of the airfoil 23 through the plurality of through-holes 63 as represented by arrows b in FIG. 4 and film-cools an outer surface of the airfoil 23.

### Regarding Optimization of Amount of Cooling Air in Turbine Stator Vane 21

Regarding the vane walls 23W on the leading edge 23L side of the turbine stator vane 21, the pressure surface 23P side and the suction surface 23S side significantly differ in pressure of the combustion gas FG acting on the vane walls 23W. Therefore, in a case where cooling air in the same cavity on a leading edge side is ejected through a film cooling hole (a through-hole) provided in a vane wall on a pressure surface side and a film cooling hole (a through-hole) provided in a vane wall on a suction surface side as in the case of, for example, a turbine stator vane in the related art, the flow rate of cooling air from the film cooling hole (the through-hole) provided in the vane wall on the suction surface side becomes excessive. As a result, the efficiency of the gas turbine 10 may be decreased.

In each of the turbine first-stage stator vanes 21A according to the several embodiments shown in FIGS. 3 to 7, the internal space 61 is partitioned by the second partition wall 72 into the pressure surface side leading edge cavity 61LP and the suction surface side leading edge cavity 61LS and the turbine first-stage stator vane 21A includes the pressure surface side through-holes 63P that open into the pressure surface side leading edge cavity 61LP and the suction surface side through-holes 63S that open into the suction surface side leading edge cavity 61LS. Accordingly, it is easy to suppress the amount of cooling air ejected through the suction surface side through-holes 63S while securing the amount of cooling air ejected through the pressure surface side through-holes 63P. Therefore, it is easy to optimize the amount of cooling air in the turbine first-stage stator vane 21A.

In addition, in each of the turbine first-stage stator vanes 21A according to the several embodiments shown in FIGS. 3 to 7, the first partition wall 71 and the second partition wall 72 define the pressure surface side leading edge cavity 61LP and the suction surface side leading edge cavity 61LS.

The pressure of the combustion gas FG acting on the vane wall 23W on the suction surface 23S side relatively rapidly decreases from the leading edge 23L side toward the trailing edge 23T side in a region relatively close to the leading edge 23L. Therefore, in a case where the suction surface side connection position Psc is relatively far from the leading edge 23L and, for example, a plurality of the suction surface side through-holes 63S that open into the same suction surface side leading edge cavity 61LS are provided to be separated from each other in an extending direction of the vane wall 23W, the flow rate of cooling air ejected through the suction surface side through-hole 63S that is provided at a position relatively close to the trailing edge 23T is likely to become excessive. Therefore, the suction surface side connection position Psc may be made close to the leading edge 23L so that the size of the suction surface side leading edge cavity 61LS is made small and a range in which the suction surface side through-holes 63S that open into the same suction surface side leading edge cavity 61LS can be provided is narrowed toward the leading edge 23L side.

In the case of each of the turbine first-stage stator vanes 21A according to the several embodiments shown in FIGS. 3 to 7, the angles θ1 and θ2 of intersection between the first virtual straight line Lv1 and the extending direction Dws of the vane wall 23W at the suction surface side connection position Psc as seen in the vane height direction h are set as described above, so that the suction surface side connection position Psc is made close to the leading edge 23L side and the size of the suction surface side leading edge cavity 61LS is made small. Therefore, a range in which the suction surface side through-holes 63S that open into the same suction surface side leading edge cavity 61LS can be provided can be narrowed toward the leading edge 23L side and it is possible to optimize the flow rate of cooling air ejected through the suction surface side through-holes 63S.

In the case of the gas turbine 10 including the turbine first-stage stator vanes 21A according to the several embodiments shown in FIGS. 3 to 7, it is possible to optimize the amount of cooling air in the turbine stator vanes 21 and to improve the efficiency of the gas turbine 10.

### Regarding Optimization of Amount of Cooling Air in Turbine Stator Vane 21

In each of the turbine first-stage stator vanes 21A according to the several embodiments shown in FIGS. 3 to 7, as shown in FIGS. 5 to 7, the angle θ3 of intersection (or the angle θ4 of intersection) between the second virtual straight line Lv2 and the extending direction Dws of the vane wall 23W at the leading edge side connection position Plc may be equal to or greater than 80 degrees and equal to or smaller than 100 degrees as seen in the vane height direction h. The reason will be described below.

As described above, the insert members 80 are formed along the inner peripheral surfaces of the pressure surface side leading edge cavity 61LP and the suction surface side leading edge cavity 61LS to match the shapes of the inner peripheral surfaces of the pressure surface side leading edge cavity 61LP and the suction surface side leading edge cavity 61LS as seen in the vane height direction h.

Therefore, regarding the inner wall surface 23Ws of the vane wall 23W, which is a wall surface defining the pressure surface side leading edge cavity 61LP, and a wall surface 72Ps of the second partition wall 72 on the pressure surface 23P side (refer to FIG. 5), an angle formed between a wall portion of the insert member 80 that extends along the inner wall surface 23Ws of the vane wall 23W and a wall portion of the insert member 80 that extends along the wall surface 72Ps of the second partition wall 72 on the pressure surface 23P side decreases as an angle θ5 formed between the two wall surfaces decreases. Therefore, it is difficult to make the positions of the cooling air holes 81 in the wall portion of the insert member 80 that extends along the inner wall surface 23Ws of the vane wall 23W close to the leading edge 23L and thus it is difficult to impingement-cool a region of the inner wall surface 23Ws of the vane wall 23W that is close to the leading edge 23L.

In addition, a bend portion R (refer to FIG. 4) extending from the wall portion of the insert member 80 that extends along the inner wall surface 23Ws of the vane wall 23W to the wall portion of the insert member 80 that extends along the wall surface 72Ps of the second partition wall 72 on the pressure surface 23P side has a somewhat large radius of curvature. Therefore, as the above-described angle θ5 decreases, the position of the bend portion R becomes farther from the leading edge 23L. Therefore, it is difficult to bring the positions of the cooling air holes 81 close to the leading edge 23L and thus it is difficult to impingement-cool the region of the inner wall surface 23Ws of the vane wall 23W that is close to the leading edge 23L.

Therefore, it is desirable that the above-described angle θ5 is equal to or greater than a somewhat large angle.

Similarly, regarding the inner wall surface 23Ws of the vane wall 23W, which is a wall surface defining the suction surface side leading edge cavity 61LS, and a wall surface 72Ss of the second partition wall 72 on the suction surface 23S side (refer to FIG. 5), an angle formed between a wall portion of the insert member 80 that extends along the inner wall surface 23Ws of the vane wall 23W and a wall portion of the insert member 80 that extends along the wall surface 72Ss of the second partition wall 72 on the suction surface 23S side decreases as an angle θ6 formed between the two wall surfaces decreases. Therefore, it is difficult to make the positions of the cooling air holes 81 in the wall portion of the insert member 80 that extends along the inner wall surface 23Ws of the vane wall 23W close to the leading edge 23L and thus it is difficult to impingement-cool a region of the inner wall surface 23Ws of the vane wall 23W that is close to the leading edge 23L.

In addition, the bend portion R extending from the wall portion of the insert member 80 that extends along the inner wall surface 23Ws of the vane wall 23W to the wall portion of the insert member 80 that extends along the wall surface 72Ss of the second partition wall 72 on the suction surface 23S side has a certain radius of curvature. Therefore, as the above-described angle θ6 decreases, the position of the bend portion R becomes farther from the leading edge 23L. Therefore, it is difficult to bring the positions of the cooling air holes 81 close to the leading edge 23L and thus it is difficult to impingement-cool the region of the inner wall surface 23Ws of the vane wall 23W that is close to the leading edge 23L.

Therefore, it is desirable that the size of the above-described angle θ6 is equal to or greater than the size of a somewhat large angle.

However, since the angle θ5 and the angle θ6 described above are supplementary angles (that is, the sum of the angle θ5 and the angle θ5 is 180 degrees), as one of the angle θ5 and the angle θ6 increases, the other of the angle θ5 and the angle θ6 decreases. Therefore, the sizes of the angle θ5 and the angle θ6 may be similar to each other.

Here, in a case where the angle θ3 of intersection (or the angle θ4 of intersection) is, for example, equal to or greater than 80 degrees and equal to or smaller than 100 degrees as described above in each of the turbine first-stage stator vanes 21A according to the several embodiments shown in FIGS. 3 to 7, the sizes of the angle θ5 and the angle θ6 described above can be made similar to each other and thus it is easy to impingement-cool the region of the inner wall surface 23Ws of the vane wall 23W that is close to the leading edge 23L.

### Regarding Angle θ7 of Intersection

In each of the turbine first-stage stator vanes 21A according to the several embodiments shown in FIGS. 3 to 7, a virtual straight line that passes through the pressure surface side connection position Ppc and the trailing edge side connection position Ptc will be referred to as a third virtual straight line Lv3.

In each of the turbine first-stage stator vanes 21A according to the several embodiments shown in FIGS. 3 to 7, of the angles of intersection between the second virtual straight line Lv2 and the third virtual straight line Lv3, an angle θ7 of intersection (refer to FIG. 5) that is on the pressure surface 23P side with respect to the second virtual straight line Lv2 and that is on the leading edge 23L side with respect to the third virtual straight line Lv3 may be equal to or greater than 80 degrees and equal to or smaller than 100 degrees as seen in the vane height direction h.

The closer the angle θ7 of intersection is to 90 degrees, the more efficiently the first partition wall 71 suppresses deformation of the second partition wall 72 such as collapse of the second partition wall 72 in a thickness direction. Therefore, with the turbine first-stage stator vanes 21 A according to the several embodiments shown in FIGS. 3 to 7, it is easy to suppress deformation of the second partition wall 72 such as collapse of the second partition wall 72 in the thickness direction.

### Regarding Angles θ8 and θ9 of Intersection

In each of the turbine first-stage stator vanes 21A according to the several embodiments shown in FIGS. 3 to 7, of the angles of intersection between a fourth virtual straight line Lv4 connecting the trailing edge side connection position Ptc and an end portion 73T (refer to FIG. 3) of the third partition wall 73 on a trailing edge side to each other and the first virtual straight line Lv1, an angle θ8 of intersection (refer to FIG. 5) that is on the pressure surface 23P side with respect to the fourth virtual straight line Lv4 and that is on the trailing edge 23T side with respect to the first virtual straight line Lv1 may be an acute angle and an angle θ9 of intersection that is on the suction surface 23S side with respect to the fourth virtual straight line Lv4 and that is on the trailing edge 23T side with respect to the first virtual straight line Lv1 may be an obtuse angle as seen in the vane height direction h.

Accordingly, the third partition wall 73 extends in a direction along a camber line CL (refer to FIG. 3) of the airfoil 23 and thus it is easy to secure the sizes of both of the internal space 61 (the pressure surface side cavity 611) on the pressure surface 23P side and the internal space 61 (the suction surface side cavity 612) on the suction surface 23S side which are partitioned by the third partition wall 73.

### Regarding Positional Relationship Between Fifth Virtual Straight Line Lv5 and Through-Hole 63

In each of the turbine first-stage stator vanes 21A according to the several embodiments shown in FIGS. 3 to 7, as shown in FIGS. 5 to 7, openings 63i of the through-holes 63 may not be present in the inner wall surface 23Ws of the vane wall 23W on the suction surface 23S side that is positioned between an intersection point P between a fifth virtual straight line Lv5 extending in a direction orthogonal to the extending direction Dws of the vane wall 23W at the pressure surface side connection position Ppc and the vane wall 23W on the suction surface 23S side and the suction surface side connection position Psc as seen in the vane height direction h.

Accordingly, it is possible to reduce the amount of cooling air for film-cooling of a region to which a relatively small thermal load is applied and to optimize the amount of cooling air in the turbine stator vane 21.

### Regarding Influence of Shape of First Partition Wall 71

Since cooling air of which the pressure is relatively high is supplied to the internal spaces, there is a phenomenon in which the airfoil swells such that the vane wall on the pressure surface side and the vane wall on the suction surface side are separated from each other.

As described above, in the turbine first-stage stator vane 21A according to the embodiment shown in FIGS. 3, 4 and 5, the first partition wall 71 is linearly formed along the first virtual straight line Lv1 that passes through the pressure surface side connection position Ppc and the suction surface side connection position Psc as seen in the vane height direction h.

Accordingly, a phenomenon in which the first partition wall 71 linearly formed along the first virtual straight line Lv1 swells such that the vane wall 23W on the pressure surface 23P side and the vane wall 23W on the suction surface 23S side are separated from each other is suppressed, and thus deformation of the airfoil 23 can be suppressed.

In the turbine first-stage stator vane 21A according to another embodiment that is shown in FIG. 6, the first partition wall 71 is bent at the trailing edge side connection position Ptc, which is a connection position between the first partition wall 71 and the second partition wall 72, as seen in the vane height direction h and the trailing edge side connection position Ptc is positioned closer to the trailing edge 23T than the first virtual straight line Lv1 is.

Accordingly, the suction surface side connection position Psc is made closer to the leading edge 23L side and the size of the suction surface side leading edge cavity 61LS is made smaller. Therefore, a range in which the suction surface side through-holes 63S that open into the same suction surface side leading edge cavity 61LS can be provided can be further narrowed toward the leading edge 23L side and it is possible to further optimize the flow rate of cooling air ejected through the suction surface side through-holes 63S.

In the turbine first-stage stator vane 21A according to still another embodiment that is shown in FIG. 7, the first partition wall 71 includes the pressure surface side region 711 that extends from the pressure surface side connection position Ppc to the trailing edge side connection position Ptc as seen in the vane height direction h and the suction surface side region 712 that extends from the connection position Pc, at which the first partition wall 71 is connected to the second partition wall 72, to the suction surface side connection position Psc as seen in the vane height direction h at a position that is closer to the leading edge 23L side than the trailing edge side connection position Ptc is.

Accordingly, the suction surface side connection position Psc is made closer to the leading edge 23L side and the size of the suction surface side leading edge cavity 61LS is made smaller. Therefore, a range in which the suction surface side through-holes 63S that open into the same suction surface side leading edge cavity 61LS can be provided can be further narrowed toward the leading edge 23L side and it is possible to further optimize the flow rate of cooling air ejected through the suction surface side through-holes 63S.

The present disclosure is not limited to the above-described embodiments, and includes modifications of the above-described embodiments and a combination of these embodiments as appropriate.

For example, in the above description, the structure of the turbine first-stage stator vane 21A has been described as the internal structure of the turbine stator vane 21 and the structure of the turbine first-stage stator vane 21A may be applied to the turbine stator vanes 21 other than the turbine first-stage stator vane 21A.

For example, the contents described in each embodiment are understood as follows.
(1) The turbine stator vane 21 according to at least one embodiment of the present disclosure includes the first partition wall 71 and the second partition wall 72 that partition the internal space 61 of the airfoil 23 and the plurality of through-holes 63 that penetrate the vane walls 23W constituting the airfoil 23. The first partition wall 71 is a partition wall that extends from the pressure surface side connection position Ppc, which is a connection position between the first partition wall 71 and the vane wall 23W on the pressure surface 23P side of the airfoil 23, to the suction surface side connection position Psc, which is a connection position between the first partition wall 71 and the vane wall 23W on the suction surface 23S side of the airfoil 23, and is provided closest to the leading edge 23L of the airfoil 23. The second partition wall 72 extends from the leading edge side connection position Plc, which is a connection position between the second partition wall 72 and the vane wall 23W on the leading edge 23L side of the airfoil 23, to the trailing edge side connection position Ptc, which is a connection position between the second partition wall 72 and the first partition wall 71, and partitions the internal space 61 into the pressure surface side leading edge cavity 61LP and the suction surface side leading edge cavity 61LS. Of the angles of intersection between the first virtual straight line Lv1 that passes through the pressure surface side connection position Ppc and the suction surface side connection position Psc and the extending direction Dws of the vane wall 23W at the suction surface side connection position Psc, the angle θ1 of intersection that is on the leading edge 23L side with respect to the first virtual straight line Lv1 is an obtuse angle and the angle θ2 of intersection that is on the trailing edge 23T side of the airfoil 23 with respect to the first virtual straight line Lv1 is an acute angle as seen in the vane height direction h of the airfoil 23. The through-holes 63 include the pressure surface side through-holes 63P that open into the pressure surface side leading edge cavity 61LP and the suction surface side through-holes 63S that open into the suction surface side leading edge cavity 61LS.

According to the configuration of (1) described above, the internal space 61 is partitioned by the second partition wall 72 into the pressure surface side leading edge cavity 61LP and the suction surface side leading edge cavity 61LS in the turbine stator vane 21 and the turbine stator vane 21 includes the pressure surface side through-holes 63P that open into the pressure surface side leading edge cavity 61LP and the suction surface side through-holes 63S that open into the suction surface side leading edge cavity 61LS. Accordingly, it is easy to suppress the amount of cooling air ejected through the suction surface side through-holes 63S while securing the amount of cooling air ejected through the pressure surface side through-holes 63P. Therefore, it is easy to optimize the amount of cooling air in the turbine stator vane 21.

According to the configuration of (1) described above, the first partition wall 71 and the second partition wall 72 define the pressure surface side leading edge cavity 61LP and the suction surface side leading edge cavity 61LS.

According to the configuration of (1) described above, the angles θ1 and θ2 of intersection between the first virtual straight line Lv1 and the extending direction Dws of the vane wall 23W at the suction surface side connection position Psc as seen in the vane height direction h are set as described above, so that the suction surface side connection position Psc is made close to the leading edge 23L side and the size of the suction surface side leading edge cavity 61LS is made small. Therefore, a range in which the suction surface side through-holes 63S that open into the same suction surface side leading edge cavity 61LS can be provided can be narrowed toward the leading edge 23L side and it is possible to optimize the flow rate of cooling air ejected through the suction surface side through-holes 63S.
(2) In several embodiments, in the configuration of (1) described above, the angle θ3 of intersection (or the angle θ4 of intersection) between the second virtual straight line Lv2 that passes through the leading edge side connection position Plc and the trailing edge side connection position Ptc and the extending direction Dws of the vane wall 23W at the leading edge side connection position Plc may be equal to or greater than 80 degrees and equal to or smaller than 100 degrees as seen in the vane height direction.

According to the configuration of (2) described above, the sizes of the angle θ5 in the pressure surface side leading edge cavity 61LP and the angle θ6 in the suction surface side leading edge cavity 61LS can be made similar to each other, and thus it is easy to impingement-cool the region of the inner wall surface 23Ws of the vane wall 23W that is close to the leading edge 23L.
(3) In several embodiments, in the configuration of (1) or (2) described above, of the angles of intersection between the second virtual straight line Lv2 that passes through the leading edge side connection position Plc and the trailing edge side connection position Ptc and the third virtual straight line Lv3 that passes through the pressure surface side connection position Ppc and the trailing edge side connection position Ptc, the angle θ7 of intersection that is on the pressure surface 23P side with respect to the second virtual straight line Lv2 and that is on the leading edge 23L side with respect to the third virtual straight line Lv3 may be equal to or greater than 80 degrees and equal to or smaller than 100 degrees as seen in the vane height direction h.

According to the configuration of (3) described above, it is easy to suppress deformation of the second partition wall 72 such as collapse of the second partition wall 72 in the thickness direction.
(4) In several embodiments, in the configuration of any one of (1) to (3) described above, the third partition wall 73 that extends toward the trailing edge 23T side from the trailing edge side connection position Ptc and that partitions the internal space 61 may be provided.

The configuration of (4) described above contributes to an increase in strength of the first partition wall 71.
(5) In several embodiments, in the configuration of (4) described above, of the angles of intersection between the fourth virtual straight line Lv4 connecting the trailing edge side connection position Ptc and the end portion 73T of the third partition wall 73 on the trailing edge 23T side to each other and the first virtual straight line Lv1, the angle θ8 of intersection that is on the pressure surface 23P side with respect to the fourth virtual straight line Lv4 and that is on the trailing edge 23T side with respect to the first virtual straight line Lv1 may be an acute angle and the angle θ9 of intersection that is on the suction surface 23S side with respect to the fourth virtual straight line Lv4 and that is on the trailing edge 23T side with respect to the first virtual straight line Lv1 may be an obtuse angle as seen in the vane height direction h.

According to the configuration of (5) described above, the third partition wall 73 extends in a direction along the camber line CL of the airfoil 23 and thus it is easy to secure the sizes of both of the internal space 61 (the pressure surface side cavity 611) on the pressure surface 23P side and the internal space 61 (the suction surface side cavity 612) on the suction surface 23S side which are partitioned by the third partition wall 73.
(6) In several embodiments, in the configuration of any one of (1) to (5) described above, the openings 63i of the through-holes 63 may not be present in the inner wall surface 23Ws of the vane wall 23W on the suction surface 23S side that is positioned between the intersection point P between the fifth virtual straight line Lv5 extending in a direction orthogonal to the extending direction Dws of the vane wall 23W at the pressure surface side connection position Ppc and the vane wall 23W on the suction surface 23S side and the suction surface side connection position Psc as seen in the vane height direction h.

According to the configuration of (6) described above, it is possible to reduce the amount of cooling air for film-cooling of a region to which a relatively small thermal load is applied and to optimize the amount of cooling air in the turbine stator vane 21.
(7) In several embodiments, in the configuration of any one of (1) to (6) described above, the suction surface side leading edge cavity 61LS may be the internal space 61 surrounded by the first partition wall 71, the second partition wall 72, and the vane wall 23W on the suction surface 23S side. The suction surface side through-holes 63S may form the through-hole rows 63L that are disposed at intervals in the vane height direction h. The number of the through-hole rows 63L may be two.

According to the configuration of (7) described above, the entirety of a region of the vane wall 23W on the suction surface 23S side that is in the vicinity of the leading edge 23L can be efficiently film-cooled by means of a relatively small amount of cooling air.
(8) In several embodiments, in the configuration of (7) described above, of the two through-hole rows 63L, the through-hole row 63L that is close to the trailing edge 23T side may intersect the first virtual straight line Lv1 as seen in the vane height direction h.

According to the configuration of (8) described above, the vane wall 23W in the vicinity of the suction surface side connection position Psc, which is difficult to impingement-cool, can be cooled through convective cooling by means of cooling air that passes through a plurality of the through-holes 63 constituting the through-hole row 63L close to the trailing edge 23T side.
(9) In several embodiments, in the configuration of any one of (1) to (8) described above, the first partition wall 71 may be linearly formed along the first virtual straight line Lv1 as seen in the vane height direction h.

According to the configuration of (9) described above, a phenomenon in which the first partition wall 71 linearly formed along the first virtual straight line Lv1 swells such that the vane wall 23W on the pressure surface 23P side and the vane wall 23W on the suction surface 23S side are separated from each other is suppressed, and thus deformation of the airfoil 23 can be suppressed.
(10) In several embodiments, in the configuration of any one of (1) to (8) described above, the first partition wall 71 may bent at the trailing edge side connection position Ptc as seen in the vane height direction h. The trailing edge side connection position Ptc may be positioned to be closer to the trailing edge 23T side than the first virtual straight line Lv1 is.

According to the configuration of (10) described above, the suction surface side connection position Psc is made closer to the leading edge 23L side and the size of the suction surface side leading edge cavity 61LS is made smaller. Therefore, a range in which the suction surface side through-holes 63S that open into the same suction surface side leading edge cavity 61LS can be provided can be further narrowed toward the leading edge 23L side and it is possible to further optimize the flow rate of cooling air ejected through the suction surface side through-holes 63S.
(11) In several embodiments, in the configuration of any one of (1) to (8) described above, the first partition wall 71 may include the pressure surface side region 711 that extends from the pressure surface side connection position Ppc to the trailing edge side connection position Ptc as seen in the vane height direction h and the suction surface side region 712 that extends from the connection position Pc, at which the first partition wall 71 is connected to the second partition wall 72, to the suction surface side connection position Psc as seen in the vane height direction h at a position that is closer to the leading edge 23L side than the trailing edge side connection position Ptc is.

According to the configuration of (11) described above, the suction surface side connection position Psc is made closer to the leading edge 23L side and the size of the suction surface side leading edge cavity 61LS is made smaller. Therefore, a range in which the suction surface side through-holes 63S that open into the same suction surface side leading edge cavity 61LS can be provided can be further narrowed toward the leading edge 23L side and it is possible to further optimize the flow rate of cooling air ejected through the suction surface side through-holes 63S.
(12) The gas turbine 10 according to at least one embodiment of the present disclosure includes the turbine stator vane 21 having a configuration according to any one of (1) to (11) described above.

According to the configuration of (12) described above, it is possible to optimize the amount of cooling air in the turbine stator vane 21 and to improve the efficiency of the gas turbine 10.

### REFERENCE SIGNS LIST

10: gas turbine
13: turbine
21: turbine stator vane (stator vane)
21A: turbine first-stage stator vane
23: airfoil
23L: leading edge
23P: pressure surface
23S: suction surface
23T: trailing edge
23w: vane wall
61: internal space
61LP: pressure surface side leading edge cavity
61LS: suction surface side leading edge cavity
63: through-hole
63L: through-hole row
63P: pressure surface side through-hole
63S: suction surface side through-hole
71: first partition wall
72: second partition wall

1. A turbine stator vane comprising:
a first partition wall and a second partition wall that partition an internal space of an airfoil; and
a plurality of through-holes that penetrate vane walls constituting the airfoil,
wherein the first partition wall is a partition wall that extends from a pressure surface side connection position, which is a connection position between the first partition wall and the vane wall on a pressure surface side of the airfoil, to a suction surface side connection position, which is a connection position between the first partition wall and the vane wall on a suction surface side of the airfoil, and is provided closest to a leading edge of the airfoil,
the second partition wall extends from a leading edge side connection position, which is a connection position between the second partition wall and the vane wall on a leading edge side of the airfoil, to a trailing edge side connection position, which is a connection position between the second partition wall and the first partition wall, and partitions the internal space into a pressure surface side leading edge cavity and a suction surface side leading edge cavity,
of angles of intersection between a first virtual straight line that passes through the pressure surface side connection position and the suction surface side connection position and an extending direction of the vane wall at the suction surface side connection position, an angle of intersection that is on the leading edge side with respect to the first virtual straight line is an obtuse angle, and an angle of intersection that is on a trailing edge side of the airfoil with respect to the first virtual straight line is an acute angle as seen in a vane height direction of the airfoil,
the through-holes include pressure surface side through-holes that open into the pressure surface side leading edge cavity and suction surface side through-holes that open into the suction surface side leading edge cavity, and
of angles of intersection between a second virtual straight line that passes through the leading edge side connection position and the trailing edge side connection position and a third virtual straight line that passes through the pressure surface side connection position and the trailing edge side connection position, an angle of intersection that is on the pressure surface side with respect to the second virtual straight line and that is on the leading edge side with respect to the third virtual straight line is equal to or greater than 80 degrees and equal to or smaller than 100 degrees as seen in the vane height direction.

2. A turbine stator vane comprising:
a first partition wall and a second partition wall that partition an internal space of an airfoil; and
a plurality of through-holes that penetrate vane walls constituting the airfoil,
wherein the first partition wall is a partition wall that extends from a pressure surface side connection position, which is a connection position between the first partition wall and the vane wall on a pressure surface side of the airfoil, to a suction surface side connection position, which is a connection position between the first partition wall and the vane wall on a suction surface side of the airfoil, and is provided closest to a leading edge of the airfoil,
the second partition wall extends from a leading edge side connection position, which is a connection position between the second partition wall and the vane wall on the leading edge side of the airfoil, to a trailing edge side connection position, which is a connection position between the second partition wall and the first partition wall, and partitions the internal space into a pressure surface side leading edge cavity and a suction surface side leading edge cavity,
of angles of intersection between a first virtual straight line that passes through the pressure surface side connection position and the suction surface side connection position and an extending direction of the vane wall at the suction surface side connection position, an angle of intersection that is on the leading edge side with respect to the first virtual straight line is an obtuse angle, and an angle of intersection that is on a trailing edge side of the airfoil with respect to the first virtual straight line is an acute angle as seen in a vane height direction of the airfoil,
the through-holes include pressure surface side through-holes that open into the pressure surface side leading edge cavity and suction surface side through-holes that open into the suction surface side leading edge cavity, and
a third partition wall that extends toward the trailing edge side from the trailing edge side connection position and that partitions the internal space is provided.

3. The turbine stator vane according to claim 2,
wherein, of angles of intersection between a fourth virtual straight line connecting the trailing edge side connection position and an end portion of the third partition wall on the trailing edge side to each other and the first virtual straight line, an angle of intersection that is on the pressure surface side with respect to the fourth virtual straight line and that is on the trailing edge side with respect to the first virtual straight line is an acute angle, and an angle of intersection that is on the suction surface side with respect to the fourth virtual straight line and that is on the trailing edge side with respect to the first virtual straight line is an obtuse angle as seen in the vane height direction.

4. A turbine stator vane comprising:
a first partition wall and a second partition wall that partition an internal space of an airfoil; and
a plurality of through-holes that penetrate vane walls constituting the airfoil,
wherein the first partition wall is a partition wall that extends from a pressure surface side connection position, which is a connection position between the first partition wall and the vane wall on a pressure surface side of the airfoil, to a suction surface side connection position, which is a connection position between the first partition wall and the vane wall on a suction surface side of the airfoil, and is provided closest to a leading edge of the airfoil,
the second partition wall extends from a leading edge side connection position, which is a connection position between the second partition wall and the vane wall on the leading edge side of the airfoil, to a trailing edge side connection position, which is a connection position between the second partition wall and the first partition wall, and partitions the internal space into a pressure surface side leading edge cavity and a suction surface side leading edge cavity,
of angles of intersection between a first virtual straight line that passes through the pressure surface side connection position and the suction surface side connection position and an extending direction of the vane wall at the suction surface side connection position, an angle of intersection that is on the leading edge side with respect to the first virtual straight line is an obtuse angle, and an angle of intersection that is on a trailing edge side of the airfoil with respect to the first virtual straight line is an acute angle as seen in a vane height direction of the airfoil,
the through-holes include pressure surface side through-holes that open into the pressure surface side leading edge cavity and suction surface side through-holes that open into the suction surface side leading edge cavity, and
the first partition wall is linearly formed along the first virtual straight line as seen in the vane height direction.

5. A turbine stator vane comprising:
a first partition wall and a second partition wall that partition an internal space of an airfoil; and
a plurality of through-holes that penetrate vane walls constituting the airfoil,
wherein the first partition wall is a partition wall that extends from a pressure surface side connection position, which is a connection position between the first partition wall and the vane wall on a pressure surface side of the airfoil, to a suction surface side connection position, which is a connection position between the first partition wall and the vane wall on a suction surface side of the airfoil, and is provided closest to a leading edge of the airfoil,
the second partition wall extends from a leading edge side connection position, which is a connection position between the second partition wall and the vane wall on the leading edge side of the airfoil, to a trailing edge side connection position, which is a connection position between the second partition wall and the first partition wall, and partitions the internal space into a pressure surface side leading edge cavity and a suction surface side leading edge cavity,
of angles of intersection between a first virtual straight line that passes through the pressure surface side connection position and the suction surface side connection position and an extending direction of the vane wall at the suction surface side connection position, an angle of intersection that is on the leading edge side with respect to the first virtual straight line is an obtuse angle, and an angle of intersection that is on a trailing edge side of the airfoil with respect to the first virtual straight line is an acute angle as seen in a vane height direction of the airfoil,
the through-holes include pressure surface side through-holes that open into the pressure surface side leading edge cavity and suction surface side through-holes that open into the suction surface side leading edge cavity,
the first partition wall is bent at the trailing edge side connection position as seen in the vane height direction, and
the trailing edge side connection position is positioned to be closer to the trailing edge side than the first virtual straight line is.

6. The turbine stator vane according to claim 1,
wherein an angle of intersection between the second virtual straight line that passes through the leading edge side connection position and the trailing edge side connection position and an extending direction of the vane wall at the leading edge side connection position is equal to or greater than 80 degrees and equal to or smaller than 100 degrees as seen in the vane height direction.

7. The turbine stator vane according to claim 1,
wherein openings of the through-holes are not present in an inner wall surface of the vane wall on the suction surface side that is positioned between an intersection point between a fifth virtual straight line extending in a direction orthogonal to an extending direction of the vane wall at the pressure surface side connection position and the vane wall on the suction surface side and the suction surface side connection position as seen in the vane height direction.

8. The turbine stator vane according to claim 1,
wherein the suction surface side leading edge cavity is the internal space surrounded by the first partition wall, the second partition wall, and the vane wall on the suction surface side,
the suction surface side through-holes form through-hole rows that are disposed at intervals in the vane height direction, and
the number of through-hole rows is two.

9. The turbine stator vane according to claim 8,
wherein, of the two through-hole rows, the through-hole row that is close to the trailing edge side intersects the first virtual straight line as seen in the vane height direction.

10. The turbine stator vane according to claim 1,
wherein the first partition wall includes a pressure surface side region that extends from the pressure surface side connection position to the trailing edge side connection position as seen in the vane height direction and a suction surface side region that extends from a connection position, at which the first partition wall is connected to the second partition wall, to the suction surface side connection position as seen in the vane height direction at a position that is closer to the leading edge side than the trailing edge side connection position is.

11. A gas turbine comprising:
the turbine stator vane according to claim 1.
